(19) United States
(12) Patent Application Publication
(10) Pub. No.: US 2016/0096196 A1
(43) Pub. Date: Apr. 7, 2016

(54) POLYOXYMETHYLENE POLYMER COMPOSITION FOR FLUIDIZED BED COATING PROCESSES AND PRODUCTS MADE THEREFROM

(71) Applicant: Ticona GmbH, Sulzbach (DE)

(72) Inventor: Nicolai Papke, Mainz-Kastel (DE)

(21) Appl. No.: 14/870,080

(22) Filed: Sep. 30, 2015

Related U.S. Application Data
(60) Provisional application No. 62/058,343, filed on Oct. 1, 2014.

(51) Int. Cl. B05D 7/14; C09D 123/08; A47L 15/50; C09D 175/04; B05D 3/04; C09D 171/02; C09D 133/02

(52) U.S. Cl. CPC B05D 7/14; C09D 171/02; C09D 123/0869; C09D 133/02; C09D 175/04; B05D 3/048; A47L 15/50; C08K 3/22

(57) ABSTRACT

Polymer particles containing a polyoxymethylene polymer for coating metallic substrates are described. The polymeric particles contain a polyoxymethylene polymer in combination with an adhesion promoter which may comprise an acid modified polyolefin and performance enhancing additives. The polyoxymethylene polymer and the adhesion promoter may also be combined with a thermoplastic elastomer and optionally a coupling agent. Also disclosed is a process where the polymeric particles are used to from a fluidized bed for coating metallic substrates. In one embodiment, after being coated with the polymer particles, the coated metal substrate is gas cooled followed by cooling the coated substrate in a bath containing an aqueous medium.

### RELATED APPLICATIONS

The present application is based on and claims priority to U.S. Provisional Patent application Ser. No. 62/058,343, filed on Oct. 1, 2014, which is incorporated herein by reference.

### BACKGROUND

Various metal parts are typically coated with polymers for various reasons. The polymer coating, for instance, can prevent the underlying metal from corroding, especially when the metal part is to be used in a corrosive environment, such as an acidic environment, an alkaline environment, or a humid environment including environments containing steam.

In one embodiment, the metal parts are powder coated. During powder coating, in order to achieve high coating thickness (above 150 micron), a metal part is dipped into a fluidized bed. The fluidized bed contains fluidized polymer particles that stick to the pre-heated metal part and form a coating upon melting.

The polymers that are used to coat the metal parts can vary depending upon the particular application. For example, polyester resins are typically used for outdoor applications. Polyester resins, for instance, have inherent UV stability. Polyester resins can also be formulated so that they will adhere to metal. Polyesters, however, are hydrolytically unstable which limits their use. For instance, polyesters are typically not well suited for use in environments where the polymer must have hot water resistance or chemical resistance, especially resistance to alkaline materials.

For example, many metal coated parts are used in applications where the part is periodically or continuously exposed to hot water, steam and/or corrosive chemicals. Coatings applied to dishwater racks, for instance, need to be stable for the entire metal part service life in hot water environments and in alkaline environments, since dishwater detergents are typically very alkaline. Thus, in the past, polymer coatings containing primarily polyamide 11, polyamide 12 polyvinyl chloride, and polyethylene have been proposed for use as a metal coating in many hot water environments and corrosive environments at continuous service temperature lower than 120° C. Polyamide 11 and polyamide 12, for instance, have adequate mechanical properties such as cut resistance, abrasion resistance and impact strength, and are chemically inert to hydrocarbons, mineral acids, and bases. Resins that contain primarily polyamide 11 and/or polyamide 12, however, have difficult coating processing in warm and humid environments and are relatively expensive.

Another type of polymer that has excellent mechanical properties and excellent chemical resistance properties are polyoxymethylene polymers. For example, polyoxymethylene polymers do not mechanically or chemically degrade when exposed to hot water, steam, or alkaline compounds. Polyoxymethylene polymers, however, have not been widely used to coat metal parts, since the polymers exhibit poor adhesion to metal surfaces. In addition, the polymers have high stiffness and high shrinkage, which can result in cracking. Once a coating cracks, for instance, the coating has a tendency to peel off and flake off easily. Those skilled in the art have attempted to address this problem by combining polyoxymethylene polymers with an assortment of additives. These formulations, however, have met market and application expectations with little success.

In view of the above, a need exists for a polymer composition containing a polyoxymethylene polymer that can be used to powder coat metal substrates.

### SUMMARY

In general, the present disclosure is directed to a polymer composition for coating metallic substrates. In one embodiment, the polymer composition may be formed into polymer particles that are used to coat a metal substrate in a fluidized bath. The present disclosure is also directed to a process for coating a metallic substrate.

In one embodiment, the polymer composition comprises a polyoxymethylene polymer, a thermoplastic elastomer, and an acid modified polyolefin. In one embodiment the polyoxymethylene polymer can be a copolymer. The thermoplastic elastomer can be present in the composition from 2% to 30% by weight. The acid modified polyolefin comprises a copolymer of a polyolefin and an unsaturated carboxylic acid. The acid modified polyolefin can be present in the composition in an amount from about 0.05% to about 18% by weight, such as from about 0.2% to about 10% by weight, such as from about 0.5% to about 2% by weight. In one embodiment, the acid modified polyolefin comprises a copolymer of ethylene and acrylic acid or methacrylic acid. The acrylic acid or methacrylic acid may be present in the copolymer in an amount from about 1% to about 25% by weight, such as in an amount from about 4% to about 9% by weight, such as in an amount from about 5% to about 8% by weight. The acid modified polyolefin in combination with the thermoplastic elastomer polymer improves the adhesion characteristics of the polyoxymethylene polymer, improves impact resistance, and improves various other properties and characteristics.

The polymer composition can also contain various other components such as an acid scavenger, a chlorine scavenger, and/or a nucleating agent. In one embodiment, the polymer composition contains a plurality of acid scavengers. Acid scavengers that may be used include zinc oxide, tricalcium citrate, a copolyamide, and mixtures thereof or organic scavengers.

As described above, the polymer composition may be formed into particles for coating metallic substrates in a fluidized bed. The average particle size D₅₀ of the powdered polymer composition is tailored to the target coating thickness required by the application of focus. The powder comprises polymeric particles having a particle size distribution such that at least about 90% of the particles have a particle size of from about 25 microns to about 300 microns.

The present disclosure is also directed to a process for coating a metallic substrate. The process includes placing a heated metallic substrate into a fluidized bed. The fluidized bed contains fluidized polymer particles. The polymer particles comprise a polyoxymethylene polymer. The polymer particles adhere and coat the preheated metallic substrate.

After the metallic substrate is coated in the fluidized bed, the coated metallic substrate can be gas cooled so that an exterior surface of the coated substrate is at a temperature of less than 100° C. The coated metallic substrate can also be further cooled by contact with an aqueous medium which may contain surfactants. For instance, the coated metallic substrate may be immersed in a water bath with a temperature of from about 20° C. to about 60° C., such as from about 25° C. to about 45° C.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying FIGURES, in which:

FIG. 1 is a perspective view of a dishwasher device that includes dishwasher racks coated in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition containing a polyoxymethylene polymer and at least one other polymer additive. The polymer composition can be ground into a powder containing polymeric particles. In accordance with the present disclosure, the powder is well suited to powder coating metal substrates.

More particularly, the polymer composition contains a polyoxymethylene polymer in combination with an impact modifier and/or an adhesion promoter. The adhesion promoter may comprise an acid modified polyolefin, such as an ethylene acrylic acid copolymer. The adhesion promoter has been found to significantly improve the adhesive properties of the composition to metal surfaces and additionally has been found to improve the flow characteristics of the composition. When the different polymers are combined together, the resulting composition has good impact resistance properties and does not significantly shrink once coated to a metal surface. Thus, the polymer composition not only adheres well to metal surfaces, but also resists cracking and flaking. Of particular advantage, since the polymer composition contains significant amounts of a polyoxymethylene polymer, the composition is also well suited for use in environments where the coated metal part may be exposed to hot water or steam. The composition is also chemical resistant and can be used in environments where exposure to alkaline compounds is expected. In this regard, metal coated parts made in accordance with the present disclosure are particularly well suited for use in dishwashers, washing machines, industrial washing systems, industrial fabric scouring systems, and the like.

As described above, the polymer composition generally contains a polyoxymethylene polymer, an impact modifier, and an adhesion promoter. In one embodiment, the polyoxymethylene polymer is also a copolymer. As used herein, a polyoxymethylene copolymer is intended to encompass any polymer having, as at least part of the polymer chain, structural units derived from trioxane and cyclic formals or their functionalized derivatives. Thus, the term “polyoxymethylene copolymer” as used herein is intended to encompass terpolymers, tetrapolymers, and the like that include structural units in the polymer chain derived from trioxane and cyclic formals or their functionalized derivatives in addition to other units, if present during polymerization. For instance, other units can be derived from trioxane or a mixture of trioxane and dioxolane and cyclic formals, e.g., cyclic ether and cyclic acetal monomers.

A copolymerization process can include synthesis of the polyoxymethylene-forming monomers. For instance, trioxane can first be formed by the trimerization of formaldehyde in an aqueous phase, and subsequent separation and purification of the formed monomer.

In one embodiment, a polyoxymethylene copolymer can be manufactured by the copolymerization of trioxane with 0.2 to 6 parts per 100 parts of trioxane of cyclic acetal containing at least one O(CH2)ₙ group where n>1. In general, the polyoxymethylene copolymer can include at least 50 mol-%, such as at least 75 mol-%, such as at least 90 mol-% and such as even at least 95 mol-% of —CH₂O-repeat units.

The copolymerization can be initiated by cationic initiator as is generally known in the art, such as organic or inorganic acids, acid halides, and Lewis acids. One example of the latter is boron fluoride and its coordination complexes with organic compounds in which oxygen or sulfur is the donor atom. The coordination complexes of boron trifluoride may, for example, be a complex with a phenol, an ether, an ester, or a dialkyl sulfide. Boron trifluoride etherate (BF₃.Et₂O) is one preferred coordination complex useful in the cationic copolymerization processes. Alternately, gaseous BF₃ may be employed as the polymerization initiator.

Catalyst concentration may be varied within wide limits, depending on the nature of the catalyst and the intended molecular weight of the copolymer. For example, catalyst concentration may range from about 0.0001 to about 1 weight percent, and in one embodiment can range from about 0.001 to about 0.1 weight percent, based on the total weight of the monomer mixture.

A chain transfer agent can also be utilized during polymerization of the monomers. In general, a relatively small amount of a chain transfer agent can be used, e.g., about 100 to about 1000 ppm.

In one embodiment, the chain transfer agent can be an acetal such as methylal, butylal, mixtures of acetals, and the like. Other typical chain transfer agents such as esters or alcohols including methyl formate, methanol, and so forth may be used.

The polyoxymethylene polymer further includes functional groups. For instance, a polyoxymethylene copolymer can be formed to include terminal groups, which can include both end group and side or pendant functional groups, such as hydroxyl groups, so as to further improve the adhesion of the polymer to metal surfaces. In one embodiment, terminal groups can also provide binding sites for formation of bonds with the polymer additives.

According to one embodiment, a polyoxymethylene copolymer can be formed to include a relatively high number of terminal hydroxyl groups on the copolymer. For example, the polyoxymethylene copolymer can have terminal hydroxyl groups, for example hydroxyethylene groups and/or hydroxyl groups, in greater than about 50% of all the terminal sites on the polymer, which includes both polymer end groups and terminal side, or pendant, groups. For instance, greater than about 70%, greater than about 80%, or greater than about 85% of the terminal groups on the polyoxymethylene copolymer may be hydroxyl groups, based on the total number of terminal groups present. In one embodiment, up to about 90%, or up to about 85% of the terminal groups on the polyoxymethylene copolymer may be hydroxyl groups. In one preferred embodiment, a polyoxymethylene copolymer can include up to about 20 hydroxyl groups per polymer chain, for instance, between about 15 and about 20 hydroxyl groups per chain.

The polyoxymethylene copolymer can have a content of terminal hydroxyl groups of at least about 5 mmol/kg, such as at least about 10 mmol/kg, such as at least about 15 mmol/kg, such as at least about 20 mmol/kg, such as at least 25 mmol/kg and generally less than about 300 mmol/kg, such as less than 200 mmol/kg. For example, the terminal hydroxyl group content ranges from about 10 mmol/kg to about 70 mmol/kg, such as from about 18 mmol/kg to about 50 mmol/kg.

A polyoxymethylene copolymer can be formed to include a high percentage of terminal hydroxyl groups through selection of the chain transfer agent used during polymerization. For instance, a glycol chain transfer agent such as ethylene glycol, diethylene glycol, mixtures of glycols, and the like can be used in a copolymerization of trioxane with a cyclic acetal containing at least one O(CH2)ₙ group where n>1. According to this embodiment, greater than about 80%, for instance greater than about 85% of the terminal end groups on the formed polyoxymethylene copolymer can be ethoxyhydroxy or —OCH₂CH₂OH (—C₂OH) end groups.

A polyoxymethylene copolymer can be formed from polymerization of one or more monomers that can produce on the copolymer various terminal groups that can provide desirable characteristics to the resulting polymer composition. For example, a copolymer can be formed so as to include terminal and/or pendant groups including, without limitation, alkoxy groups, formate groups, acetate groups and/or aldehyde groups. The terminal groups can be functional as formed, and can provide bonding sites for bonding with one or more components. Alternatively, the formed copolymer can be further treated to form functional groups. For example, following formation, the copolymer can be subjected to hydrolysis to form the desired terminal groups on the copolymer.

Any of a variety of different monomers can be copolymerized with one or more other polyoxymethylene-forming monomers, e.g., trioxane. Monomers can include, without limitation, cyclic formals having pendant acrylate or substituted acrylate ester groups, cyclic ethers, cyclic acetals, and so forth. By way of example, trioxane can be copolymerized with 1,2,6-hexanetriol formal or its ester derivatives; ester derivatives glycerol formal; glycidyl ester derivatives; and trimethylolpropane formal derivatives. Monomers can include, without limitation, α,α- and α,β-isomers of glycerol formal, such as glycerol formal acetate (GFA), glycerol formal methacrylate, glycerol formal crotanate, and glycerol formal chloracetate; glycerol formal formate (GFF); 1,2,6-hexanetriol formal acetate; glycidyl acrylate; 5-ethyl-5-hydroxymethyl-1,3-dioxane (EHMDO); EHMDO ester of acetic acid; EHMDO ester of acrylic acid; EHMDO ester of 3-choro-propanoic acid; EHMDO ester of 2-methylacrylic acid; EHMDO ester of 3-methylacrylic acid; EHMDO ester of undedocenoic acid; EHMDO ester of cinnamic acid; EHMDO ester of 3,3-dimethylacrylic acid; and so forth.

A monomer can include a terminal group that is much less reactive during polymerization as compared to the formal group itself or the trioxane, e.g., an ester group, a formate group, or an acetate group. Accordingly, the terminal group can remain unreacted during polymerization to form an essentially linear polymer with side chain functionality. This side chain functionality can be suitable for use as is or, alternatively, can be hydrolyzed following polymerization to yield pendant hydroxyl functional groups. Hydrolysis following polymerization can also remove unstable hemiacetal end groups and improve the stability of the resulting copolymers.

In one preferred embodiment, a polyoxymethylene copolymer can be formed via the copolymerization of trioxane with between about 0.2 and about 6 parts GFF per 100 parts trioxane or 0.2 to 6 parts of a combination of 1,3-dioxolane and GFF per 100 parts trioxane, using ethylene glycol as the chain transfer agent. This copolymer, following hydrolysis, can have about 80% or higher —C₂OH end groups and up to 20 to 30 pendant —OH groups per chain. This copolymer is referred to throughout this disclosure as lateral-OH polyoxymethylene.

Multiple monomers may be employed in forming the disclosed copolymers so as to form tri- or tetra-polymers. For instance, a trioxane can be polymerized with a mixture of dioxolane and one or more of the cyclic formals described above. Additional monomers as are generally known in the art can be incorporated in disclosed copolymer. Exemplary monomers can include ethylene oxide, 1,3-dioxolane, 1,3-dioxepane, 1,3-dioxep-5-ene, 1,3,5-trioxepane, and the like.

The polymerization can be carried out as precipitation polymerization or in the melt. By a suitable choice of the polymerization parameters, such as duration of polymerization or amount of chain transfer agent, the molecular weight and hence the melt index value of the resulting polymer can be adjusted. The polyoxymethylene polymer can generally have a melt flow rate of from about 0.5 g/10 minutes to about 70 g/10 minutes, such as from about 1 g/10 minutes to about 60 g/10 minutes. In one embodiment, a polyoxymethylene polymer having a higher melt flow rate may be used. For instance, the polyoxymethylene polymer may have a melt flow rate of greater than about 2 g/10 minutes, such as greater than about 5 g/10 minutes. Melt flow rate is generally less than about 70 g/10 minutes, such as less than about 60 g/10 minutes, such as less than about 40 g/10 minutes. Melt flow rate of the polymer composition is measured at 190° C. and with a load of 2.16 kg according to ISO 1133.

The amount of the polyoxymethylene copolymer present in a polymer composition can vary. In one embodiment, for instance, the composition contains the polyoxymethylene copolymer in an amount of at least about 40% by weight, such as in an amount greater than about 60% by weight, such as in an amount greater than about 65% by weight, such as in an amount greater than about 70% by weight. In general, the polyoxymethylene copolymer is present in an amount less than about 95% by weight, such as in an amount less than about 90% by weight, such as in an amount less than about 85% by weight.

The polyoxymethylene copolymer present in the polymer composition can be a blend of polyoxymethylene copolymers. For instance, the polymer composition can contain a first polyoxymethylene polymer and a second polyoxymethylene polymer, where the first and second polyoxymethylene polymers are different by at least one characteristic or property.

In addition to a polyoxymethylene polymer, the composition further includes an impact modifier and an adhesion promoter. The impact modifier in combination with the adhesion promoter have been found to improve adhesion to metal surfaces, to improve impact strength, to improve the flow characteristics of the composition, to lower the stiffness of the polyoxymethylene polymer, and/or to lower the shrinkage characteristics of the polymer. Reducing the modulus of elasticity and shrinkage prevents the coating from later cracking and flaking off.

The impact modifier can comprise a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic elastomer is used that contains carbonate groups. It was discovered that the presence of carbonate groups in the thermoplastic elastomer greatly enhances the ability of the impact modifier to resist hydrolysis, especially in comparison to other thermoplastic elastomers. Thus, thermoplastic elastomers having carbonate groups are well suited for use in wet, high humidity and/or highly alkaline environments and/or at service temperatures above 40° C.

The thermoplastic polyurethane elastomer, for instance, may have at least one soft segment of a long-chain dial and/or carbonate groups and a hard segment derived from a diisocyanate and a chain extender. Representative long-chain dials are polyester dials such as poly(butylene adipate)diol, poly(ethylene adipate)diol and poly(ε-caprolactone)diol; and polyether dials such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic dials such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

Thermoplastic elastomers containing carbonate groups can be produced, in one embodiment, using a diol component that contains carbonate groups. For instance, the thermoplastic elastomer can be produced as described above by reacting together a polymer diol containing carbonate groups with an isocyanate and a chain extender. The polymer diol, for instance, may comprise a polycarbonate diol and/or a polyester polycarbonate diol.

A polycarbonate diol may be produced by reacting a diol with a carbonate compound. The carbonate compound may comprise, for instance, a carbonate compound with alkyl groups, a carbonate compound with alkylene groups, or a carbonate compound containing aryl groups. Particular carbonate compounds include dimethyl carbonate, diethyl carbonate, ethylene carbonate, and/or diphenyl carbonate. A polyester polycarbonate, on the other hand, may be formed by reacting a dial with a carbonate compound as described above in the presence of a carboxylic acid.

As described above, the polycarbonate groups contained in the thermoplastic elastomer are generally referred to as soft segments. Thus, the polycarbonate groups have a tendency to lower the hardness of the thermoplastic elastomer. In one embodiment, for instance, the shore A hardness of the thermoplastic elastomer is less than about 98, such as less than about 95, such as less than about 93 when tested according to ISO Test 868. The shore A hardness of the material is generally greater than about 80, such as greater than about 85.

The amount of impact modifier contained in the polymer composition can vary depending on many factors. The amount of impact modifier present in the composition may depend, for instance, on the type of polyoxymethylene polymer present. In general, one or more impact modifiers may be present in the composition in an amount greater than about 5% by weight, such as in an amount greater than about 10% by weight. The impact modifier is generally present in an amount less than 30% by weight, such as in an amount less than about 25% by weight. For instance, the thermoplastic elastomer may be present in an amount from about 15% to about 25% by weight.

The polyoxymethylene polymer may also be combined with an adhesion promoter. In one embodiment, the adhesion promoter comprises an acid modified polyolefin. The acid modified polyolefin can be a combination of ethylene and an acid-containing unsaturated or saturated monocarboxylic or dicarboxylic acid. Unexpectedly, it was discovered that an acid modified polyolefin not only improves adhesion, but has also been found to improve the flow characteristics of the polyoxymethylene polymer.

The acid modified polyolefin, as described above, can be produced using an unsaturated carboxylic acid. The unsaturated carboxylic acid can have a carbon chain length of from about 2 carbon atoms to about 12 carbon atoms, such as from about 3 carbon atoms to about 8 carbon atoms. Particular unsaturated acids that may be used to modify a polyolefin include acrylic acid, methacrylic acid, and combinations thereof.

In one embodiment, the adhesion promoter comprises an ethylene acrylic acid copolymer and/or an ethylene methacrylic acid copolymer. In one particular embodiment, an ethylene acrylic acid copolymer is used that contains acrylic acid in an amount from about 1% to about 25% by weight, such as from about 4% to about 9% by weight, such as from about 5% to about 8% by weight, such as an amount from about 6% to about 7% by weight. The ethylene acrylic acid copolymer can have a melt flow rate of from about 1 g/10 minutes to about 50 g/10 minutes, such as from about 5 g/10 minutes to about 15 g/10 minutes, when measured at 190° C. and at a load of 2.16 kg.

As used herein, an adhesion promoter or acid modified polyolefin does not encompass ionomers. Ionomers, for instance, can adversely interfere with the polyoxymethylene polymer.

The adhesion promoter is present in the polymer composition generally in an amount greater than about 0.05% by weight, such as an amount greater than 0.2% by weight, such as an amount greater than about 0.5% by weight. The adhesion promoter is generally present in an amount less than about 18% by weight, such as an amount less than about 15% by weight, such as an amount less than about 10% by weight, such as an amount less than about 8% by weight, such as an amount less than about 5% by weight. In one particular embodiment, the adhesion promoter is present in an amount from about 1% to about 2% by weight.

Optionally, the polymer composition may also contain a coupling agent. The coupling agent can be capable of coupling the impact modifier to the polyoxymethylene polymer. In one embodiment, for instance, the coupling agent may be capable of forming covalent bonds with the terminal hydroxyl groups on the polyoxymethylene polymer and with functional groups on the impact modifier.

In one embodiment, the coupling agent comprises a polyisocyanate, such as a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate, dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

When present, the coupling agent can be present in the composition in an amount generally from about 0.1% to about 5% by weight. In one embodiment, for instance, the coupling agent can be present in an amount from about 0.1% to about 2% by weight, such as from about 0.2% to about 1% by weight. In an alternative embodiment, the coupling agent can be added to the polymer composition in molar excess amounts when comparing the reactive groups on the coupling agent with the amount of terminal hydroxyl groups on the polyoxymethylene polymer.

The polymer composition of the present disclosure can optionally contain a stabilizer and/or various other additives. Such additives can include, for example, antioxidants, acid scavengers, UV stabilizers or heat stabilizers. In addition, the composition may contain processing auxiliaries, for example, lubricants, nucleating agents, fillers, reinforcing materials or antistatic agents and additives which impart a desired property to the material.

In general, each additive can be present in the polymer composition in an amount up to about 10% by weight, such as from about 0.1% to about 5% by weight, such as from about 0.1 to about 2% by weight.

For example, the polymeric composition can include an acid scavenger that can prevent acid catalyzed hydrolytic decomposition of the polyoxymethylene. The inclusion of an acid scavenger may be of particular benefit at high temperature/high humidity processing conditions. By way of example, an acid scavenger can include, without limitation, hydroxides, oxides, carbonates, silicates, inorganic acid salts, phosphates, hydrogen phosphates, and carboxylic acid salts of alkali metals and alkaline earth metals. Examples can include calcium hydroxide; magnesium hydroxide; barium hydroxide; lithium, sodium, calcium, or aluminum (hydroxyl)carbonates such as calcium carbonate, magnesium carbonate, barium carbonate, calcium silicate, magnesium silicate, calcium laurate, magnesium laurate, calcium stearate, magnesium stearate, zinc stearate, calcium behenate, magnesium behenate, calcium lactate, calcium stearoyl lactylate, zinc oxide, natural and synthetic hydrotalcites, sodium phosphate, sodium hydrogen phosphate, and the like. In one embodiment, the acid scavenger can be a hydroxystearate salt, for instance calcium, magnesium, or zinc hydroxystearate.

Particular examples of acid scavengers that may be used in the polymer composition include zinc oxide, magnesium oxide, calcium citrate, tricalcium citrate, and combinations thereof.

In addition to inorganic acid scavengers, in other embodiments, an organic acid scavenger may also be used. For example, the organic acid scavenger may comprise a thermoplastic polyamide resin. In one embodiment, for instance, an acid scavenger is incorporated in to the composition that comprises a copolyamide. The copolyamide can have an acid value and an amine value of between about 1 and 18 mg KOH/g, such as less than about 12 mg KOH/g, such as less than about 10 mg KOH/g, such as less than about 8 mg KOH/g, such as less than about 6 mg KOH/g.

Acid scavengers may be used alone or in combination with other acid scavengers. In one particular, embodiment, at least two acid scavengers are contained in the polymer composition. For instance, in one particular embodiment, the polymer composition contains tricalcium citrate and/or zinc oxide, wherein each acid scavenger is present in an amount from about 0.5% to about 5% by weight, such as from about 0.5% to about 2% by weight. In addition to tricalcium citrate and/or zinc oxide, the polymer composition can further contain a copolyamide acid scavenger in an amount less than about 2% by weight, such as an amount less than about 1% by weight, such as an amount from about 0.01% to about 0.5% by weight.

In one embodiment, the polymer composition can further contain a chlorine scavenger. The chlorine scavenger may comprise, for instance, an oligomeric hindered amine light stabilizer. Particular chlorine scavengers include include 2,2,6,6-tetramethyl-4-piperidyl compounds, e.g., bis(2,2,6,6-tetramethyl-4-piperidyl) sebacate or the polymer of dimethyl succinate, 1-(2-hydroxyethyl)-4-hydroxy-2,2,6,6-tetramethyl-4-piperidine, Bis(1,2,2,6,6-pentamethyl-4-piperidinyl)-[[3,5-bis(1,1-dimethylethyl)-4-h-ydroxyphenyl]methyl]butylmalonate, or 3,9-bis(2-hydroxy-1,1-dimethylethyl)-2,4,8,10-tetraoxaspiro[5,5]undecane.

When present, the chlorine scavenger can be included in the polymer composition in an amount less than about 2% by weight, such as an amount less than about 1% by weight. For instance, the chlorine scavenger can be present in an amount from about 0.05% to about 1% by weight, such as from about 0.05% to about 0.5% by weight.

The polymer composition may also contain an antioxidant. One example of an antioxidant that may be present in the composition comprises a sterically hindered phenolic antioxidant. Examples of such compounds, which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], hexamethylene glycol bis[3-(3,5-di-tert-butyl-4-hydroxyphenyl)propionate], and 3,5-di-tert-butyl-4-hydroxytoluene.

In one embodiment, the composition may also contain one or more lubricants. The lubricant may comprise a polymer wax composition. Lubricants that may be included in the composition include, for instance, N,N′-ethylene bisstearamide (EBS). In one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount from about 0.01% to about 5% by weight. For instance, a lubricant can be present in an amount greater than about 0.1% by weight, such as in an amount from about 0.1% to about 1% by weight. The above polyethylene glycol polymer can also be present in an amount up to about 5% by weight. For instance, the polyethylene glycol polymer can be present in an amount from about 0.1% to about 5% by weight, such as from about 0.5% to about 3% by weight.

In one embodiment, the polymer composition may include a surfactant, such as a polymer surfactant. For example, in one embodiment, the surfactant may comprise a polyoxyalkylene. The polyoxyalkylene, for instance, may comprise polyethylene glycol having a molar mass of from about 20,000 g/mol to about 60,000 g/mol, such as from about 30,000 g/mol to about 40,000 g/mol. In other embodiments, the polymer surfactant may comprise an amide wax, an olefin wax, or the like. When present, the polymer surfactant may be contained in the polymer composition in an amount less than about 5% by weight, such as in an amount from about 0.05% to about 4% by weight, such as in an amount from about 1% to about 3% by weight.

The polymer composition may further contain a nucleating agent. The nucleating agent, for instance, may comprise a polyoxymethylene terpolymer. Alternatively, the nucleating agent may comprise finely divided inorganic particles such as talc. The nucleating agent may be present in the polymer composition in an amount less than about 5% by weight, such as an amount less than about 2% by weight, such as an amount less than about 1% by weight. The nucleating agent may be present in the composition in an amount greater than about 0.05% by weight, such as an amount greater than about 0.1% by weight.

The polymer composition of the present disclosure also generally contains a performance enhancing additive.

The performance enhancing additive can be a coloring agent. The coloring agent may comprise any suitable pigment, which includes dyes and/or pigment blends. The pigment may comprise an inorganic pigment or an organic pigment. Pigments that may be present in the composition include, for instance, titanium dioxide, ultramarine blue, cobalt blue, phthalocyanines, anthraquinones, mixtures thereof, and the like. Other colorants can include carbon black or various other polymer-soluble dyes. Other coloring agent can include pearlescent pigments such as aluminum flakes and bimetallic pigments. The coloring agents can be present alone or in combination in an amount up to about 2% by weight, such as in an amount from about 0.01% to about 1% by weight. In one embodiment, the coloring agent may be added to the polymer composition as a masterbatch.

In one embodiment the coloring agent is used to modulate the gloss of the coating, achieving high gloss (higher than 60) or low gloss (lower than 15). An example but not limited to of such coloring agent are gloss microbeads.

The performance enhancing additive can also be an additive used to increase the thermal conductivity of the polymer composition. Examples but not limited to of such performance enhancing additives are carbon blacks, graphene, graphites, carbon nanotubes and mixtures thereof.

The performance enhancing additive can be an anti-static additive. Anti-static additives that may be useful in the present disclosure include hydroxyl alkyl amines, ethoxylated alkyl amines, polyol amines, glycidylmonistearate, alkyl sulfonic acid salts, alkane sulfonates, organotitanates such as titanium tri-isostearoyl-isopropoxide, titanium tris (dioctylphosphato) isopropoxide, or mixtures thereof.

In still another embodiment, the performance enhancing additive may comprise a fluidizing aid. The fluidizing aid, in one embodiment, can be present in combination with an anti-static additive. Fluidizing aids include silica, including layered silica, clays, talc, calcium carbonate, dolomite, vermiculite, and mixtures thereof. The fluidizing aid may be in the form of a micropowder and/or a fume. The fluidizing aid, for instance, can have a particle size of less than about 10 microns, such as less than about 5 microns, such as less than about 2 microns. The particle size is generally greater than 0.01 microns.

When forming a powder for powder coating metallic substrates, the above described components can be melt blended together. In one embodiment, melt blending the components together can cause a reaction to occur between the polyoxymethylene polymer and the impact modifier.

In one embodiment, the components in the composition are mixed together and then melt blended in an extruder. Processing temperatures can vary from about 160° C. to about 240° C., and particularly from about 165° C. to about 200° C. The duration of mixing can be from about 0.5 minutes to about 60 minutes.

Extruded strands can be produced which are then pelletized. Next, the pelletized compound can be ground to a suitable particle size and to a suitable particle size distribution to produce a powder that is well suited for use in fluidized applications.

In one embodiment, any suitable grinding device or mill may be used to reduce the particle size. In one particular embodiment, however, cryogenic grinding is used to reduce the size of the particles. In some embodiments, for instance, the polymer composition may tend to be relatively soft and therefore cryogenic grinding can be used to not only obtain the desired reduced particle size, but also to obtain particles that have a form factor less than two and having an appropriate particle size distribution. Form factor is defined as the ratio of the longest to the lowest length of a particle.

For example, in one embodiment, the polymeric particles of the powder can have a particle size distribution such that at least about 90% of the particles have a particle size of from about 25 microns to about 300 microns, and particularly from about 50 microns to about 250 microns. In one embodiment, for instance, at least about 90% of the particles have a particle size of from about 100 microns to about 250 microns, such as from about 100 microns to about 200 microns. Larger particles, for instance, have a tendency not to coat appropriately metallic substrates through a fluidized bed process, forming uneven films and can be difficult to fluidize. Smaller particles, on the other hand, can be expelled out of the fluid bed tank in fumes, cause instability of a fluid bed, cause the formation of static electricity, resulting in the need for an anti-static agent.

During cryogenic grinding, the polymer pellets are kept at very low temperatures and then processed in a grinding device, such as in a hammermill a granulator or pin mill. The temperature of the pellets can be reduced using various methods. In one embodiment, for instance, the temperature of the pellets is reduced by contact with liquid nitrogen. In other embodiments, the pellets can be refrigerated.

In one particular embodiment, for instance, a cryogenic liquid, such as liquid nitrogen, is directly injected in with a gas flow to pre-cool the pellets before the pellets enter the impact area of the mill. The cryogenic liquid also cools the mill as the polymer composition is ground. The liquid nitrogen, for instance, may be at a temperature of less than about −129° C., such as at a temperature of less than about −180° C. In one embodiment the mill outflow powder and gas stream is at temperature lower than 0° C. and above −80° C., preferably between −70° C. and −5° C.-and more preferably between −60° C. and −10° C.

After grinding, the polymer particles may be filtered through a screen or multiple screens and also fed through a cyclone or air classifier, powder collection and a bag house to separate oversize and fines from the gas flow. The screen, for instance, may have a 50 mesh size to ensure that the particles have a particle size of less than about 300 microns. The cyclone, on the other hand, may remove fines, such as particles having a size of less than about 50 microns. In one particular embodiment, for instance, the resulting powder may contain particles having a size between about 100 nm and 1 mm, such as from about 100 microns to about 200 microns.

After the powder is produced and collected, the powder can then be loaded into a fluidized bed and fluidized using a suitable gas flow. For instance, nitrogen gas, air or any other suitable gas may be used to fluidize the bed. A metal substrate is then preheated to a temperature sufficient to cause the polymer particles to stick to the surface of the metal substrate and flow forming a coating. The metal substrate, for instance, may be heated to a temperature greater than about 200° C., such as greater than about 220° C., such as greater than about 240° C. and at a temperature generally less than about 500° C., such as less than about 450° C. The metal substrate is maintained in the fluidized bed until a sufficient amount of polymer particles have become attached to the metal part in order to form a continuous coating.

In one embodiment, the metal substrate may be pre-treated with a pre-treatment which may include but not limited to sand blasting and degreasing or the use of a primer composition prior to being immersed in the fluidized bed. The primer composition may comprise various pretreatment chemicals. Surface pretreatment of the metal substrate can improve adhesion between the metal substrate and the polymer coating and/or improve overall corrosion protection.

In one embodiment, the metal substrate is first cleaned by being fed through a degreasing process, a cleaning process, and/or a rinsing process. For example, in one embodiment, the metal substrate may be sprayed with a degreasing agent under pressure to remove any residual grease-like substances on the surface of the part. Next, the metal substrate can be subjected to a cleaning process. For instance, the metal substrate can be dipped into a heated bath containing an alkaline cleanser. The cleaning bath, for instance, can be at a temperature of greater than about 40° C., such as greater than about 50° C. and at a temperature of less than about 80° C., such as less than about 70° C., such as less than about 60° C. Once the metal substrate is degreased and cleaned, the metal substrate can be rinsed with water.

The degreasing, cleaning and/or rinsing steps should remove any residual contaminants on the metal substrate including welding and process aids. Once cleaned, the metal substrate may undergo a surface modification process. During the surface modification process, for instance, the surface may be pre-coated with a primer composition. The primer composition may comprise an oxide or a phosphate. In one embodiment, for instance, the primer composition comprises a metal phosphate. The metal phosphate may comprise zinc phosphate, manganese phosphate, nickel phosphate, iron phosphate, or mixtures thereof. For example, in one embodiment, the metal substrate may be dipped into a bath containing a metal phosphate, such as iron phosphate. The bath can be at a temperature of greater than about 20° C., such as greater than about 30° C., such as greater than about 40° C. The bath temperature is generally less than about 80° C., such as less than about 70° C., such as less than about 60° C. The metal substrate is dipped in the bath for a time sufficient to form a suitable pre-coat on the surface of the substrate. In one embodiment, for instance, the metal substrate may be dipped into the phosphate bath for a time of greater than about 20 seconds, such as greater than about 30 seconds, such as greater than about 40 seconds, such as greater than about 50 seconds. The metal substrate can remain in the phosphate bath for extended periods of time without adverse effects in many applications. In a continuous run process, the metal substrate remains in the bath for less than about 8 hours.

In addition to or instead of a phosphate, the primer composition may contain a titanate or siliconate and/or also contain an oxide, such as a zirconium oxide. A zirconium oxide can be applied to the surface of the metal substrate using substantially the same procedure as described above with respect to the metal phosphate.

After the metal substrate is treated with the primer composition, the metal substrate can be rinsed if desired. The metal substrate can be rinsed in water, for instance, by dipping or spraying. In one embodiment, the pretreated metal substrate can be rinsed with mineralized water at ambient temperature.

After rinsing, the pretreated metal substrate can undergo a passivation process, followed by a rinsing step and a drying step. The pretreated metal substrate can be dried at ambient temperature or can be placed in an oven. For instance, the oven temperature can be from about 80° C. to about 150° C., such as from about 115° C. to about 125° C.

After the metal substrate has been pretreated with a primer composition, the metal substrate can be preheated prior to being contacted with the fluidized bed containing the polymer particles. As described above, the pretreated metal substrate can be preheated to a temperature sufficient to cause the polymer particles to stick to the surface of the metal substrate and flow forming a coating. For instance, the metal substrate can be preheated to a temperature of greater than about 60° C., such as greater than about 80° C., such as greater than about 100° C., such as greater than about 120° C., such as greater than about 140° C., such as greater than about 160° C. The metal substrate is generally preheated to a temperature of less than about 440° C.

After preheating, the pretreated metal substrate is dipped into the fluidized bed. The amount of time that the metal substrate is maintained in the fluidized bed can depend on various factors including the polymer composition of the polymer particles, the desired thickness of the coating, the shape of the metal part, and the temperature of the metal substrate and the fluidized bed. In general, the metal substrate is maintained in the fluidized bed for a relatively short period of time, such as less than about 20 seconds, such as less than about 15 seconds, such as less than about 10 seconds, such as even less than about 5 seconds. In one embodiment, for instance, the metal substrate is placed in the fluidized bed in amount of time from about 1 second to about 10 seconds, such as from about 3 seconds to about 5 seconds.

In one embodiment, after the coated metal substrate is removed from the fluidized bed, the coated metal substrate is further vibrated to ensure a homogeneous layer deposition of polymer particles to the metal substrate, and then heated and/or annealed in an oven. Heating the coated metal substrate may further cause the polymer composition to flow and evenly coat the surface of the metal substrate. The temperature and the time that the coated metal substrate is post heated can depend on various factors. In general, the coated metal substrate is post heated at a temperature greater than the melting temperature of the polymer composition but less than the degradation temperature of the polymer composition. As used herein, the degradation temperature is the temperature at which the polymer composition begins to form and release gases. In one embodiment, post heating can take place in an environment heated to a temperature of greater than about 200° C., such as greater than about 210° C., such as greater than about 220° C., such as greater than about 230° C., such as greater than about 240° C. The temperature is generally less than about 300° C., such as less than about 280° C., such as less than about 260° C. The metal substrate can undergo post heating for a time of from about 30 seconds to about 10 minutes, such as from about 30 seconds to about 5 minutes, such as from about 30 seconds to about 3 minutes. In one embodiment, the coated metal substrate is post heated for a time of from about 1 minute to about 3 minutes.

The thickness of the coating applied to the metal substrate can vary depending upon the particular application. In one embodiment, for instance, the coating can have a thickness of from about 0.01 mm to about 1 mm, such as from about 0.1 mm to about 0.5 mm. The coating, however, in other applications may be greater than 1 mm, such as from about 1 mm to about 3 mm depending upon the end use of the coated metallic part.

After the metal substrate is coated with the polymer composition, the metal substrate is cooled to ambient temperature. The manner in which the polymer coating is cooled can impact various characteristics and properties of the resulting product. In particular, the present Inventors discovered that a two-step cooling process can dramatically improve smoothness and/or gloss and/or flexibility of the resulting coating. In one embodiment, for instance, the coated metal substrate is first gas cooled followed by cooling in an aqueous solution.

For example, after post heating, the coated metal substrate can be gas or air cooled for a short period of time prior to being immersed in a water bath. In general, the coated metal substrate is gas cooled for a time sufficient so that the coated metal substrate will not cause gas bubbles to form in a water bath when later immersed. For instance, the coated metal substrate can be gas cooled such that the outer surface of the coating is at a temperature of less than about 100° C., such as less than about 95° C., such as less than about 90° C., such as less than about 85° C., such as less than about 80° C. In one embodiment, for instance, the coated metal part can be air cooled at ambient temperature for a time of from about 10 seconds to about 5 minutes, such as from about 10 seconds to about 2 minutes, such as from about 20 seconds to about 1 minute. In one particular embodiment, for instance, the coated metal substrate can be gas cooled for a time of from about 20 seconds to about 40 seconds.

After being gas cooled, the coated metal part is then immersed in a water bath. The water bath is at a temperature less than the temperature of the coated metal substrate. For instance, the water bath can be the temperature of less than about 50° C., such as less than about 45° C. The temperature of the water bath is generally greater than about 10° C., such as greater than about 20° C., such is greater than about 23° C. In one embodiment, the water bath is at a temperature of from 25° C. to about 40° C. The coated metal substrate is immersed in the water bath for a time sufficient to fix the morphology of the polymer coating. In one embodiment, for instance, the coated metal part can be immersed in the water bath for a time of from about 10 seconds to about 3 minutes, such as from about 20 seconds to about 2 minutes, such as from about 20 seconds to about 1 minute. It should be understood, however, that the amount of time and temperature of the water bath can vary depending upon numerous factors.

In one embodiment, the water bath may contain various other additives. For instance, in one embodiment, the water bath can contain a detergent. The detergent can be present in the water bath in an amount less than about 2% by weight, such as in an amount from about 0.01% to about 2% by weight, such as from about 0.05% to about 0.8% by weight.

In addition to coating metallic parts using a fluidized bed, metallic substrates can also be coated using flocking, minicoating, thermal spraying, electrostatic coating techniques or any other suitable spraying techniques.

Polymeric particles made in accordance with the present disclosure are well suited for use in coating metallic substrates. In fact, the composition of the present disclosure offers various advantages and benefits, especially when coating metallic substrates for use in corrosive environments. For example, due to the amount of polyoxymethylene polymer present in the polymer particles, the particles are capable of forming coatings that do not degrade when exposed to higher temperatures, hot water, and/or steam. Further, the coatings are resistant to chemical attack. The coatings, for example, are particularly resistant to alkaline compounds.

Because the polyoxymethylene polymer has functional terminal groups, the polymer has been found to have improved adhesion to metal surfaces. The one or more polymer additives blended with the polyoxymethylene polymer can serve to further improve adhesion. The one or more polymer additives can also lower the stiffness of the material and thus make coatings made according to the present disclosure resist cracking. For instance, coatings made according to the present disclosure can have a modulus of elasticity of generally less than about 2200 MPa, such as less than about 2000 MPa, such as less than about 1800 MPa. The modulus of elasticity of the coatings is generally greater than 1200 MPa, such as greater than about 1500 MPa. Modulus is determined according to ISO 527.

The one or more polymer additives can also improve the shrinkage properties of the polyoxymethylene polymer. Compositions made according to the present disclosure, for instance, may display shrinkage values of less than about 1.8%, such as less than about 1.7%, such as less than about 1.6%. The shrinkage of the polymer is generally greater than about 1%, such as greater than about 1.2%. Shrinkage is determined according to ASTM Test D955 (ISO 2577).

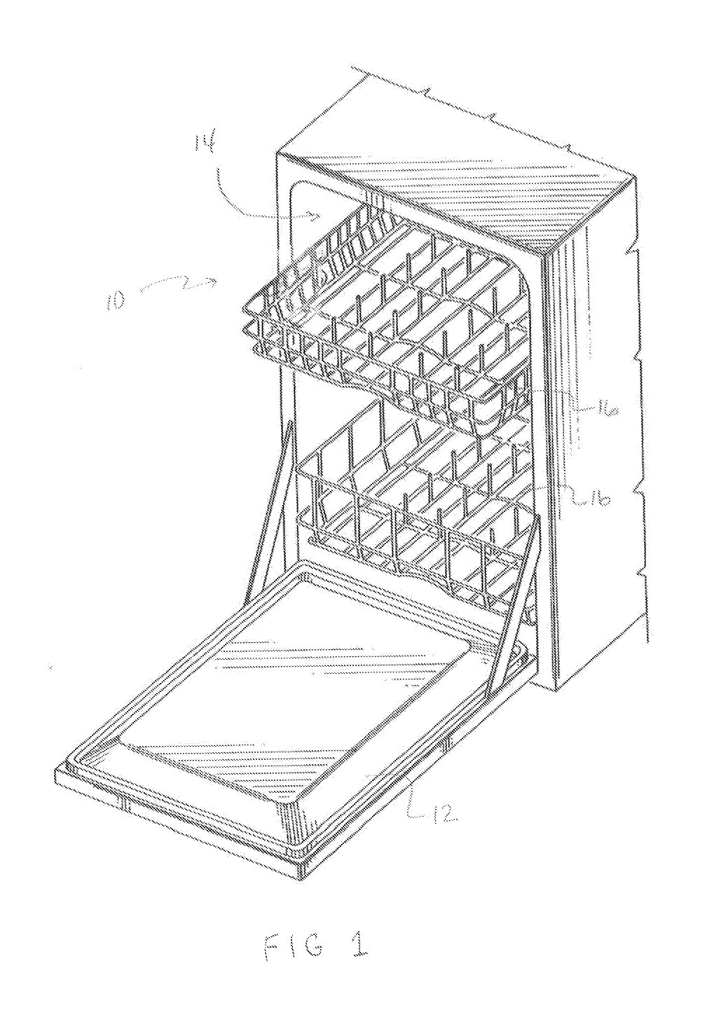

Various different metallic parts can be coated in accordance with the present disclosure. In one embodiment, for instance, the polymer composition can be used to coat pipe and/or wire goods such as a rack intended for use in a dishwasher. For instance, referring to FIG. 1, a dishwasher 10 is illustrated. The dishwasher 10 includes a door 12 that opens and closes to a washing chamber 14. The washing chamber 14 contains one or more dishwasher racks 16 that include tines for holding dishes and/or utensils. The dishwasher racks 16 comprise a metal substrate that has been coated with a polymer composition in accordance with the present disclosure.

In addition to dishwasher racks, the coating process of the present disclosure may be used to coat staircase rails, fences, concrete steel rebars, orthopedic equipment and medical equipment such as ambulant transport, support for handicap toilets, bathroom equipment and/or to produce parts for refrigerators, freezers, washing machines, such as washing machine agitators, parts for industrial washing systems, and parts for fabric scouring systems. The process of the present disclosure can also be used to produce clips, fasteners, suspension springs and polymer coated automotive parts.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a polyoxymethylene polymer or copolymer thereof
a thermoplastic elastomer; and
an acid modified polyolefin, the acid modified polyolefin comprising a copolymer of a polyolefin and an unsaturated carboxylic acid, the acid modified polyolefin being present in the composition in an amount from about 0.2% to about 18% by weight.

2. A polymer composition as defined in claim 1, further comprising a coupling agent for coupling together the polyoxymethylene polymer and the thermoplastic elastomer.

3. A polymer composition as defined in claim 1, wherein the acid modified polyolefin comprises a copolymer of ethylene and acrylic acid or methacrylic acid.

4. A polymer composition as defined in claim 1, wherein the acid modified polyolefin comprises a copolymer of ethylene and acrylic acid, the copolymer containing acrylic acid in an amount from about 1% to about 25% by weight.

5. A polymer composition as defined in claim 1, wherein the thermoplastic elastomer comprises a thermoplastic polyurethane elastomer.

6. A polymer composition as defined in claim 1, wherein the thermoplastic elastomer is present in the composition in an amount from about 10% to about 30% by weight.

7. A polymer composition as defined in claim 2, wherein the coupling agent comprises a polyisocyanate.

8. A polymer composition as defined in claim 1, further comprising an acid scavenger.

9. A polymer composition as defined in claim 8, wherein the acid scavenger comprises zinc oxide.

10. A polymer composition as defined in claim 8, wherein the polymer composition contains a plurality of acid scavengers.

11. A polymer composition as defined in claim 10, wherein the acid scavengers comprise zinc oxide, tricalcium citrate, a copolyamide, or mixtures thereof.

12. A polymer composition as defined in claim 1, wherein the composition further contains a chlorine scavenger.

13. A polymer composition as defined in claim 1, wherein the composition further contains a nucleating agent.

14. A polymer composition as defined in claim 1, wherein the polyoxymethylene polymer includes terminal hydroxyl groups in an amount from about 10 mmol/kg to about 70 mmol/kg, and wherein the polyoxymethylene polymer has a melt index of from about 1 g/10 minutes to about 70 g/10 minutes, when measured at 190° C. and in a load of 2.16 kg.

15. A polymer composition as defined in claim 1, wherein the polyoxymethylene polymer is a blend of polyoxymethylene copolymers.

16. A polymer composition as defined in claim 1, further containing a performance enhancing additive.

17. A polymer composition as defined in claim 16, wherein the performance enhancing additive comprises a coloring agent, a surface active agent, a thermal conductive additive, an electro-conductive additive, an anti-static additive, a fluidizing aid, or mixtures thereof.

18. A polymer composition as defined in claim 1, wherein the polymer composition has been compounded by melt blending and then subjected to cryogenic grinding to produce polymer particles, the polymer particles having a particle size distribution of from 100 nm to 1 mm.

19. An article having a two dimensional or three dimensional geometry coated with a polymer composition as defined in claim 1.

20. A rack for a dishwasher comprising a plurality of tines for holding dishes, the rack comprising a metal substrate coated with a polymer composition as defined in claim 1.

21. An article coated with a polymer composition as defined in claim 1, the article comprising a railing, a fence, a rebar, a medical device, an ambulant transport part, a refrigerator part, a washing machine part, a clip, a fastener, a suspension spring, or an automotive part.

22. A process for coating a metallic substrate comprising:
gas cooling a coated metallic substrate, the metallic substrate being coated by a composition comprising polymeric particles, the polymeric particles containing a polyoxymethylene polymer; and
further cooling the coated metallic substrate by contact with an aqueous medium.

23. A process as defined in claim 22, wherein the coated metallic substrate is coated and removed from a fluidized bed and further post heated prior to being gas cooled.

24. A process as defined in claim 22, wherein the polymeric particles comprise the polyoxymethylene polymer combined with an acid modified polyolefin and a thermoplastic elastomer, the acid modified polyolefin comprising a copolymer of a polyolefin and an unsaturated carboxylic acid.

25. A process as defined in claim 22, wherein the metallic substrate is pretreated with a primer composition prior to being placed in a fluidized bed for coating the substrate.

26. A process as defined in claim 25, wherein the primer composition comprises a metal phosphate or a zirconium oxide.
